(19) United States
(12) Patent Application Publication
(10) Pub. No.: US 2026/0170841 A1
(43) Pub. Date: Jun. 18, 2026

(54) APPARATUS AND METHOD FOR ASSISTING TRAILER HITCHING BASED ON OBJECT RECOGNITION

(71) Applicants: HYUNDAI MOTOR COMPANY, Seoul (KR); KIA CORPORATION, Seoul (KR)

(72) Inventor: Min Chul Kang, Hwaseong-si (KR)

(73) Assignees: HYUNDAI MOTOR COMPANY, Seoul (KR); KIA CORPORATION, Seoul (KR)

(21) Appl. No.: 19/380,328

(22) Filed: Nov. 5, 2025

(30) Foreign Application Priority Data
Dec. 18, 2024 (KR) 10-2024-0189826

(51) Int. Cl. G06V 20/56; G06V 10/34; G06V 10/44; G06V 10/70

(52) U.S. Cl. CPC G06V 20/56; G06V 10/34; G06V 10/44; G06V 10/70

(57) ABSTRACT

A computer-implemented method for assisting trailer hitching includes: initially detecting a trailer ball and a coupler using a machine learning model based on a rear-view image of a vehicle; displaying the trailer ball and the coupler on a display using a first visual element based on the initial detection; performing first object recognition on the coupler using the machine learning model based on the rear-view image; displaying a location and a shape of the coupler on the display using a second visual element based on the first object recognition; performing second object recognition on the trailer ball and the coupler using the machine learning model based on a rear-top view image of the vehicle; and displaying locations and shapes of the trailer ball and the coupler on the display using a third visual element based on the second object recognition.

### CROSS-REFERENCE TO RELATED APPLICATION

This application claims the benefit of and priority to Korean Patent Application No. 10-2024-0189826, filed on Dec. 18, 2024, the disclosure of which is hereby incorporated herein by reference in its entirety.

### TECHNICAL FIELD

The present disclosure relates to an apparatus and a method for assisting trailer hitching based on object recognition.

### BACKGROUND

The statements in this section merely provide background information related to the present disclosure and do not necessarily constitute prior art. A coupler of a trailer is a component designed to connect the trailer to a vehicle set up for towing, such as a truck, i.e., a tow vehicle, tow rig, towing vehicle, or the like. The coupler is coupled with a trailer ball mounted on the rear of the truck and transmits traction force to the truck. A camera mounted on the towing vehicle or truck and a vehicle display system are used to support hitching between the trailer and the truck. The vehicle display system provides a rear-view image to the driver such that the driver can visually confirm the hitching position of the coupler and the trailer ball. However, the display system simply provides a rear-view image and thus cannot sufficiently assist precise hitching between the coupler and the trailer ball.

Object detection is a technique for identifying the location and type of an object in an image or video. For example, object detection can be utilized to detect a trailer or a coupler on a road. Instance segmentation is a technique for individually separating detected objects to provide accurate contours and locations. For example, instance segmentation can extract the contour of a detected coupler. Object recognition is a technique for identifying detected objects. For example, object recognition can identify the shape or state of a coupler on the basis of a result of instance segmentation.

Augmented reality (AR) is technology for superimposing digital information on an image of the real world. AR is realized by displaying an image captured by a rear camera of a vehicle on a display and overlaying virtual graphic elements on the displayed image. In vehicle display systems, AR technologies such as reverse guidance and hazard warning signs are introduced to aid drivers intuitively understanding information on the surroundings of vehicles.

### SUMMARY

Objects of the present disclosure are to provide an apparatus and a method for assisting trailer hitching based on object recognition.

Specifically, in order to assist trailer hitching, rather than simply displaying a rear-view image on a vehicle display, the positions and shapes of a coupler and a trailer ball are recognized on the basis of rear-view and rear-top view images of the vehicle. The recognized positions, shapes, and a reverse path of the vehicle are displayed as visual elements on the display. This improves user experience (UX) such that a driver can perform trailer hitching more intuitively and accurately.

The objects to be achieved by the present disclosure are not limited to the objects mentioned above. Other objects that are not mentioned should be more clearly understood by those of ordinary skill in the art from the description below. According to an embodiment of the present disclosure, an artificial intelligence model can accurately recognize a coupler and a trailer ball by utilizing not only a rear-view image of a vehicle but also a rear-top view image in an object recognition process.

An embodiment of the present disclosure provides a computer-implemented method for assisting trailer hitching. The method includes a process of initially detecting a trailer ball and a coupler using a machine learning model based on a rear-view image of a vehicle. The method also includes a process of displaying the trailer ball and the coupler on a display using a first visual element based on a result of the initial detection. The method further includes a process of performing first object recognition on the coupler using the machine learning model based on the rear-view image and a process of displaying a location and a shape of the coupler on the display using a second visual element based on a result of the first object recognition. The method also includes a process of performing second object recognition on the trailer ball and the coupler using the machine learning model based on a rear-top view image of the vehicle and a process of displaying locations and shapes of the trailer ball and the coupler on the display using a third visual element based on a result of the second object recognition.

Another embodiment of the present disclosure provides an apparatus for assisting trailer hitching. The apparatus includes at least one memory in which instructions are stored and at least one processor. The at least one processor performs, by executing the instructions, a process of initially detecting a trailer ball and a coupler using a machine learning model based on a rear-view image of a vehicle. The processor also performs a process of displaying the trailer ball and the coupler on a display using a first visual element based on a result of the initial detection. The processor also performs a process of performing first object recognition on the coupler using the machine learning model based on the rear-view image and a process of displaying a location and a shape of the coupler on the display using a second visual element based on a result of the first object recognition. The processor also performs a process of performing second object recognition on the trailer ball and the coupler using the machine learning model based on a rear-top view image of the vehicle and a process of displaying locations and shapes of the trailer ball and the coupler on the display using a third visual element based on a result of the second object recognition.

According to an embodiment of the present disclosure, when the artificial intelligence model learns to recognize the coupler and the trailer ball as objects, the artificial intelligence model can simplify the coupler and the trailer ball into shapes such as triangles, dots, or circles and learn the same. This reduces the amount of computations and aids in determining trailer hitching clearly and rapidly.

According to an embodiment of the present disclosure, by displaying the positions and shapes of the coupler, the trailer ball, and a reverse path of the vehicle as visual elements on the display, user experience (UX) can be improved such that the driver can perform trailer hitching more intuitively and accurately.

The technical effects of the present disclosure are not limited to the technical effects described above. Other technical effects not mentioned herein may be more clearly understood by those of ordinary skill in the art to which the present disclosure belongs from the description below.

### BRIEF DESCRIPTION OF THE DRAWINGS

FIG. 1 is a block diagram of an apparatus for assisting trailer hitching according to an embodiment of the present disclosure.

FIG. 2 is a flowchart schematically illustrating a method of assisting trailer hitching according to an embodiment of the present disclosure.

FIG. 3 is a diagram visually illustrating the method of FIG. 2.

FIG. 4 is a diagram of a rear-view image of a vehicle according to an embodiment of the present disclosure.

FIG. 5 includes diagram views (a)-(d) illustrating first object recognition according to an embodiment of the present disclosure.

FIG. 6 includes diagram views (a)-(d) illustrating second object recognition according to an embodiment of the present disclosure.

FIG. 7 is a diagram of a rear-top view image according to an embodiment of the present disclosure.

FIG. 8 is a chart showing examples of user interfaces (UIs) displayed on a display in the method of FIG. 2.

FIG. 9 is a block diagram schematically illustrating a configuration of one example of a computing device that can be used to implement the apparatus and methods described in the present disclosure.

FIG. 10 is a diagram illustrating a case in which an artificial intelligence model learns couplers and trailer balls by simplifying the same into shapes according to an embodiment of the present disclosure.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude other components unless specifically stated to the contrary. The terms such as ‘unit’, ‘module’, and the like refer to one or more units for processing at least one function or operation, which may be implemented by hardware, software, or a combination thereof. When a component, device, unit, module, controller, element, or the like of the present disclosure is described as having a purpose or performing an operation, function, or the like, the component, device, unit, module, controller, or element should be considered herein as being “configured to” meet that purpose or to perform that operation or function. The present disclosure describes various modules for a hitching assist system. The modules or other such components may separately embody or be included with a processor and a memory, such as a non-transitory computer readable media, as part of the module or component.

The following detailed description, together with the accompanying drawings, is intended to describe embodiments of the present disclosure. The embodiments are not intended to represent the only embodiments in which the present disclosure may be practiced.

A “vehicle” or “truck” according to an embodiment of the present disclosure may function as a towing vehicle that performs a trailer hitching operation and a towing operation.

In this specification, the term “initial detection” is a conceptual term that generically represents a step of detecting a coarse position of an object as a step before object detection.

In this specification, the term “image” may be used interchangeably with “video”. In a technical context, video and image are different concepts, but in the computer vision field, the two terms may be used interchangeably depending on a specific situation.

In this specification, the term “overlay” may be used interchangeably with “display”.

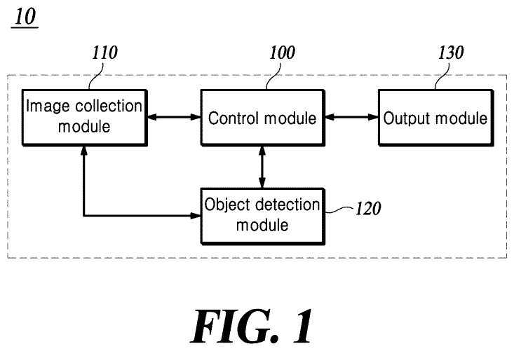

FIG. 1 is a block diagram of an apparatus for assisting trailer hitching according to an embodiment of the present disclosure.

Referring to FIG. 1, the apparatus 10 for assisting trailer hitching according to an embodiment of the present disclosure may include an image collection module 110, a control module 100, an output module 120, and an object recognition module 130. The components illustrated in FIG. 1 represent functionally distinguished elements, and one or more components may be integrated in an actual physical environment. It should be readily understood by those having ordinary skill in the art that the mutual positions of the components may be changed in accordance with the performance or structure of the system.

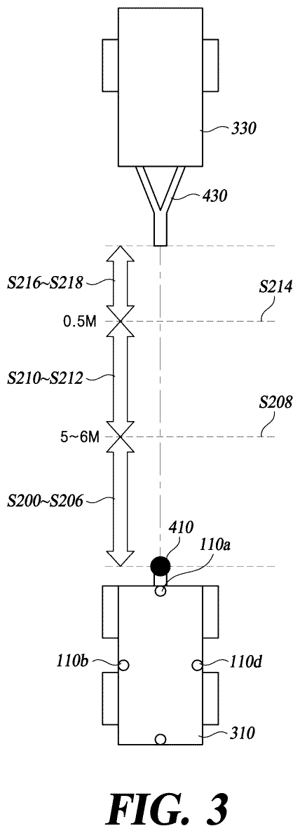

The image collection module 110 may include a plurality of cameras 110a to 110d (see FIG. 3). The cameras 110a to 110d may include an image sensor, such as a complementary metal-oxide semiconductor (CMOS), a charge-coupled device (CCD), or an active pixel sensor, and any one of a rectilinear lens, a concave lens, a convex lens, a wide-angle lens, or a fish-eye lens. The cameras 110a to 110d may be analog or digital cameras.

Referring to FIG. 3, the cameras 110a to 110d may be located at the front, rear, and/or left and right sides of a vehicle, which may provide a full view of the surroundings of the vehicle. The image collection module 110 may collect surrounding images including roads, a trailer, pedestrians, etc. by capturing images of the full surroundings of the vehicle using the cameras 110a to 110d.

The control module 100 may include at least one core capable of executing at least one instruction. The control module 100 may execute instructions stored in a memory. The control module 100 may be a single processor or multiple processors.

The control module 100 may be composed of at least one of an advanced driver assistance system (ADAS), a central processing unit (CPU), a microprocessor, a graphic processing unit (GPU), application specific integrated circuits (ASICs), and field programmable gate arrays (FPGAs), but is not limited thereto.

The control module 100 may generate an image displaying the surroundings of the vehicle in various views by synthesizing the images of the surroundings of the vehicle collected by the image collection module 110. For example, an image displaying a 360° variable 3D view or a top view may be generated. A rear-view image may mean an image displaying the rear view of the vehicle captured by the cameras 110a to 100d mounted on the vehicle. A rear-top view image may mean an image that is reconstructed by synthesizing collected images of the surroundings of the vehicle to show the rear view of the vehicle from a perspective looking down from the top of the vehicle. Since a method of processing images collected by multiple cameras 110a to 110d mounted on the vehicle to generate images of various views is known in the art and thus a detailed description thereof has been omitted.

The object recognition module 120 may include a machine learning model (not shown). A machine learning model according to an embodiment of the present disclosure is the same concept as an artificial intelligence-based module or model, an artificial intelligence module or model, an operation model, a network function, a neural network, or the like.

The machine learning model according to an embodiment of the present disclosure may recognize and process image data collected by the image collection module 110. For example, the machine learning model may detect a coupler and a trailer ball on the basis of image data, and extract feature points of the coupler and the trailer ball. The machine learning model may segment the coupler and the trailer ball into pixels on the basis of the extracted feature points and extract contours (instance segmentation). The machine learning model may recognize the shapes of the coupler and the trailer ball on the basis of the extracted contours.

For example, the shape of a general hitch coupler is usually an A type or a Y type coupler, and is a triangle-like shape. The shape of a general trailer ball is a sphere shape in a rear view and is limited to a circle shape in a rear-top view. Therefore, considering the structural features of the coupler and the trailer ball, the machine learning model can learn the shapes of the coupler and the trailer ball using simplified figures of the shapes of the coupler and the trailer ball.

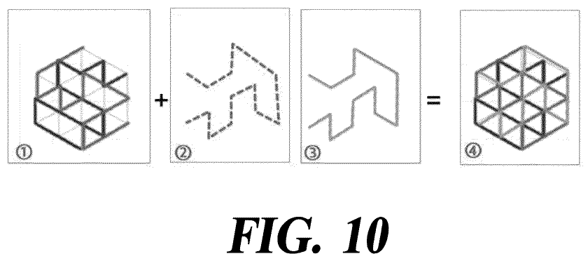

For example, referring to FIG. 10, assuming that \textcircled{4} of FIG. 10 is a shape of a combined coupler and trailer ball, an AI model can learn \textcircled{1} of FIG. 10 as a shape of a trailer ball recognized from rear-view and rear-top view images of the vehicle. The AI model can also learn \textcircled{3} of FIG. 10 as a shape of a coupler recognized from a long distance (a first object recognition execution time, which is described below, rear view). The AI model can also learn \textcircled{3} of FIG. 10 as a shape of the coupler recognized from a short distance (a second object recognition execution time, which is described below, rear-top view). Thus, similar to shape merging, the AI model can clearly and rapidly infer whether the coupler and the trailer ball are combined in a state in which the AI model has learned an ideal combined shape (\textcircled{4} of FIG. 10) that is known in advance.

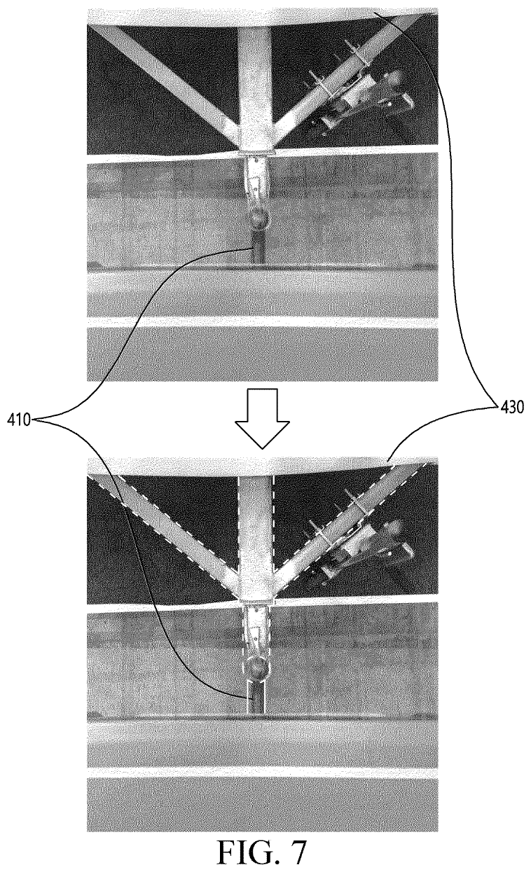

For example, referring to FIG. 7, the machine learning model may learn a coupler 430 by simplifying the same into a triangle shape and learn a trailer ball 410 by simplifying the same into a dot or circle shape. In this manner, the machine learning model can learn and infer a combined shape of the coupler and the trailer ball by simplifying the same into a shape in which a triangle and a dot or a circle are merged.

If machine learning training data is simplified into shapes such as triangles, dots, or circles and used for training, the amount of data and the amount of computation can be reduced. Simplified training data makes it easier to recognize patterns in a feature point extraction and classification process. If the combined shape of the coupler and the trailer ball is learned as a merged shape of a dot or a circle and a triangle, it is possible to clearly and rapidly infer whether or not the coupler and the trailer ball are combined, i.e., hitched to one another.

The process of performing object recognition, feature point extraction, and instance segmentation using a machine learning model is well known in the art. Thus, a detailed description thereof has been omitted.

The output module 130 may include a display. The display included in the output module 130 may include one or more of a liquid crystal display (LCD), an organic light emitting diode (OLED) display, a light emitting diode (LED) display, a flat panel display, and a head-up display (HUD), but is not limited thereto.

The output module 130 may display a rear-view or rear-top view image using the display. The rear-view or rear-top view image may include a trailer, surrounding vehicles, a coupler, a trailer ball, etc. The output module 130 may display the coupler and the trailer ball recognized in the rear-view or rear-top view image by overlaying visual elements such as dots and lines thereon on the display.

The “modules” 100, 110, 120, and 130 described in the present disclosure may refer to software-based components designed to perform the aforementioned operations within the trailer hitching assistance apparatus 10. Each module may be implemented as a memory (not shown) that stores data for an algorithm for performing the aforementioned operation or a program that reproduces the algorithm. Each module may also be implemented as a processor (not shown) that performs the aforementioned operation using the data stored in the memory. For example, each module may be individually executed on one or more computing devices, or multiple modules may be executed in parallel on the same computing device.

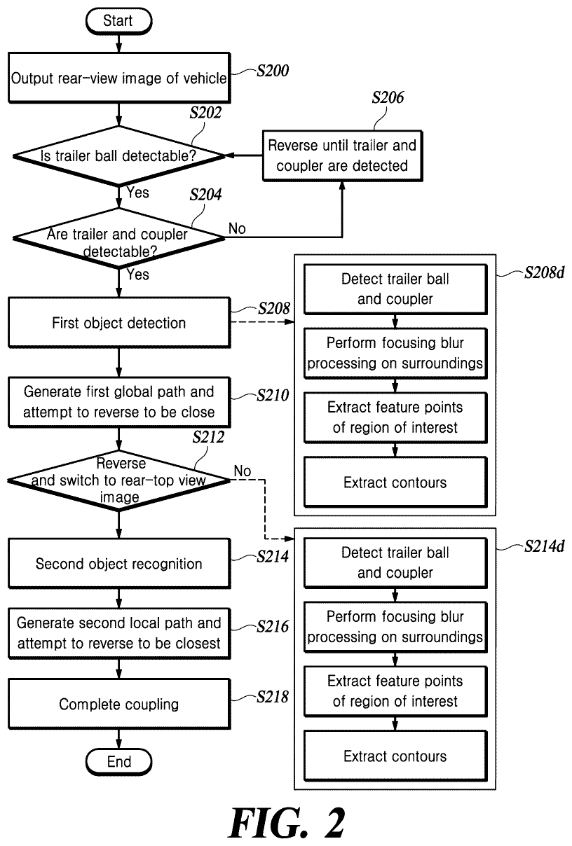

FIG. 2 is a flowchart schematically illustrating a method of assisting trailer hitching according to an embodiment of the present disclosure.

FIG. 3 is a diagram visually illustrating the process or method of FIG. 2.

The process of S200 to S206 is a process in which a vehicle 310 including the trailer hitching assistance apparatus 10 starts reversing to hitch a trailer 330 thereto.

The vehicle 310 may include a trailer ball 410. The vehicle 310 is driven in reverse while displaying a rear-view image by the output module 130 (S200).

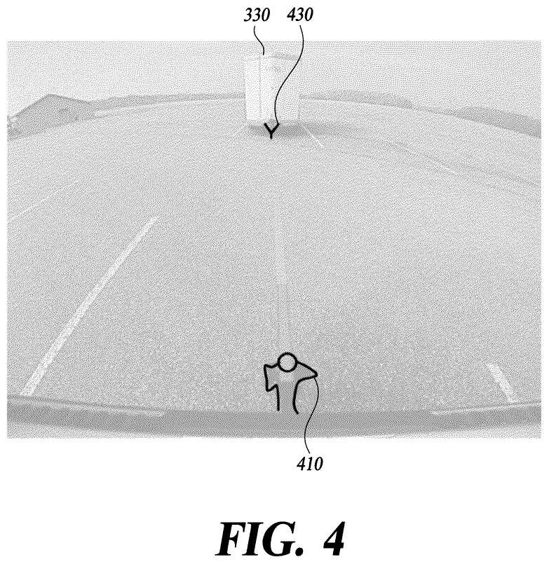

FIG. 4 is a rear view image output to a display according to an embodiment of the present disclosure. The object recognition module 120 may recognize the trailer ball 410 installed on the vehicle 310 on the basis of the rear-view image (S202). The output module 130 may display the recognized trailer ball 410 as a visual element such as a dot or a line on the display. For example, as shown in FIG. 4, the contour of the trailer ball 410 can be displayed as a dot and a line.

When the vehicle 310 comes to a distance of about 5 to 6 m from the trailer 330, the object recognition module 120 may recognize the trailer 330 and the coupler 430 (S204). The aforementioned 5 to 6 m is one example of the noted distance. The distance at which the object recognition module 120 can recognize the trailer 330 and the coupler 430 is determined by the processing capability of the cameras 110a to 110d or an object recognition algorithm and is not limited thereto.

If the object recognition module 120 cannot recognize the trailer 330 and the coupler 430 (NO at S204), the vehicle 310 continues to reverse until the trailer 330 can be recognized (S206).

The process S208 is a first object recognition process, in which the object recognition module 120 recognizes the coupler 430 on the basis of the rear-view image. When the object recognition module 120 can recognize the trailer 330, the coupler 430 can also be recognized (YES at S204).

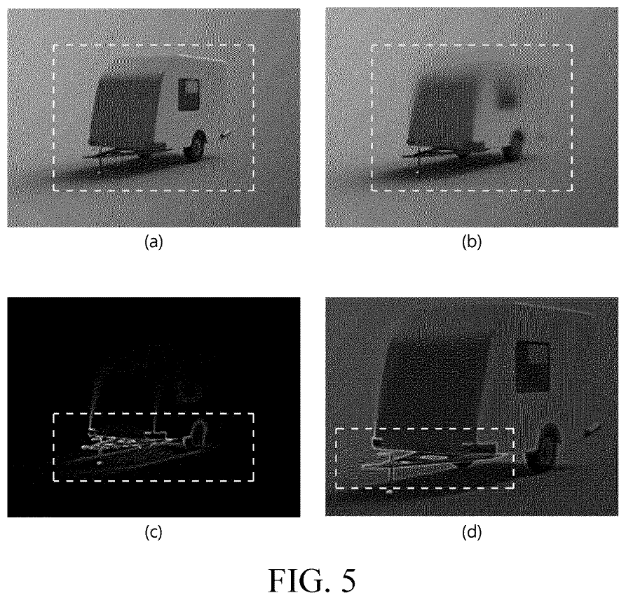

FIG. 5 is a diagram illustrating first object recognition according to an embodiment of the present disclosure. Referring to view (a) of FIG. 5, the object recognition module 120 may initially detect the trailer 330 using an object detection algorithm on the basis of rear-view image data collected from the image collection module 110. Referring to view (b) of FIG. 5, the object recognition module 120 may apply focusing blur to the detected trailer 330. Referring to view (c) of FIG. 5, the object recognition module 120 may set a region of interest (ROI) where a coupler is likely to be located. Referring to view (d) of FIG. 5, the object recognition module 120 may extract feature points within the region of interest and extract the contour of the coupler 430 by applying edge detection and contour detection techniques. The specific process S208d of the first object recognition described above is one example of a process for recognizing the coupler 430, and the applied algorithm or technique is not limited thereto.

The output module 130 may display the coupler 430 recognized from the rear-view image as a visual element such as a line on display. For example, the contour of the coupler 430 may be displayed as a line as in FIG. 4.

The processes of S210 to S212 are processes after the vehicle 310 performs the first object recognition.

The control module 100 may generate a first path (S210) such that the vehicle 310 can reach the trailer 330 on the basis of the result of performing the first object recognition. The first path means a global path from the point where the first object recognition is performed to the trailer 330. For example, the global path means the entire path through which the vehicle 310 reaches the trailer 330. The global path is a concept commonly used in the autonomous driving field, and thus a detailed description has been omitted.

The vehicle 310 continues to reverse along the first path. When the vehicle 310 reaches a distance of about 0.5 m from the trailer 330, the object recognition module 120 may perform second object recognition. The aforementioned 0.5 m is one example of the noted distance. In order to perform the second object recognition, the output module 130 switches the image displayed on the display from the rear-view image to a rear-top view image (S212).

The process S214 is a process in which the object recognition module 120 recognizes the coupler 430 and the trailer ball 410 on the basis of the rear-top view (second object recognition).

If the object recognition module 120 utilizes both the rear view and the rear-top view to recognize the coupler 430 and the trailer ball 410, the accuracy of object recognition can be improved.

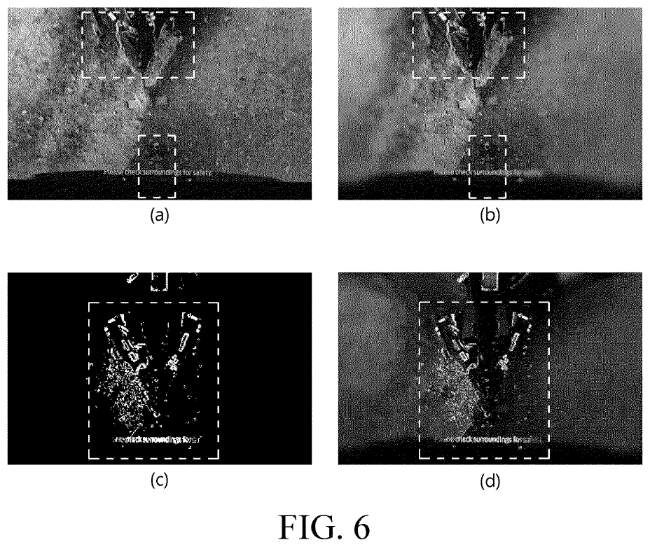

FIG. 6 is a diagram illustrating the second object recognition according to an embodiment of the present disclosure. Referring to view (a) of FIG. 6, the object recognition module 120 may initially detect the coupler 430 and the trailer ball 410 using an object detection algorithm on the basis of rear-top view image data collected from the image collection module 110. Referring to view (b) of FIG. 6, the object recognition module 120 may apply focusing blur to the detected coupler 430 and trailer ball 410. Referring to view (c) of FIG. 6, the object recognition module 120 may set a region of interest (ROI) where the coupler 430 and trailer ball 410 are likely to be located. Referring to view (d) of FIG. 6, the object recognition module 120 may extract feature points within the region of interest and extract the contour of the coupler 430 by applying edge detection and contour detection techniques. The specific process S214d of the second object recognition described above is one example of a process for recognizing the coupler 430 and the trailer ball 410, and the applied algorithm or technique is not limited thereto.

The output module 130 may display the coupler 430 and the trailer ball 410 detected from the rear-top view image data as visual elements such as lines on the display. For example, as shown in FIG. 7, the contours of the coupler 430 and the trailer ball 410 can be overlaid on the rear-top view image displayed on the display.

The processes of S216 to S218 are the processes from when the vehicle 310 performs the second object recognition until the vehicle 310 is coupled or hitched with the trailer.

The control module 100 may generate a second path such that the vehicle 310 can reach the trailer 330 on the basis of the result of performing the second object recognition (S216). The second path refers to a local path from the point where the second object recognition is performed to the trailer 330. For example, the local path refers to a path that is immediately adjusted based on the global path to reflect the current positions of the vehicle 310 and the coupler 430. The local path is a concept commonly used in the autonomous driving field, and thus a detailed description has been omitted.

The vehicle 310 may reverse to become closest to the coupler 430 on the basis of the second path. As a result, the driver can be assisted in coupling or hitching the coupler 430 and the trailer ball 410 on the basis of the locations, states, shapes, etc. of the coupler 430 and the trailer ball 410 displayed on the display (S218).

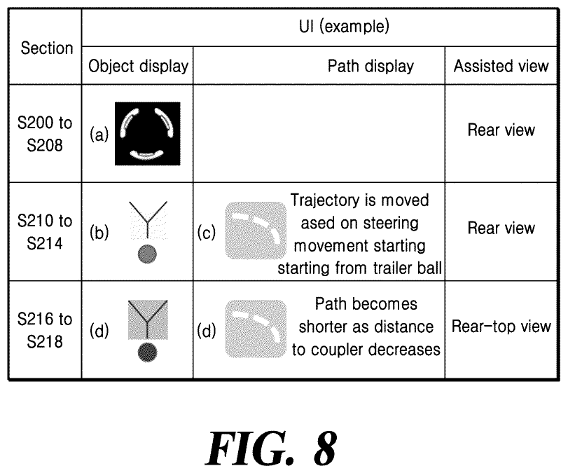

FIG. 8 is a table summarizing examples of user interfaces (UIs) output on the vehicle display in the process of FIG. 2.

S200 to S208 are processes from when the vehicle 310 starts reversing to be coupled with the trailer 330 until the first object recognition is performed. The object recognition module 120 may initially detect the trailer 330 and the coupler 430 from a long, i.e., far, major, etc., distance, but cannot perform object recognition. Accordingly, the output module 130 may roughly display the location of the coupler on the display as a circle like (a) in FIG. 8.

S210 to S214 are processes from when the first object recognition is performed until the second object recognition is performed. The output module 130 may display the contours of the coupler 430 and the trailer ball 410 on the display using visual elements such as a dot and/or a line of (b) in FIG. 8 on the basis of the result of performing the first object recognition. The output module 130 may display the first path generated by the control module 100 on the display using a visual element such as a dotted line of (c) in FIG. 8.

S216 to S218 are processes from when the second object recognition is performed until the trailer ball 410 and the coupler 430 are combined or hitched to one another. The output module 130 may display the contours of the coupler 430 and the trailer ball 410 on the display using visual elements such as a dot and/or a line of (d) in FIG. 8 on the basis of the result of performing the second object recognition. The output module 130 may display the second path generated by the control module 100 on the display using a visual element such as a dotted line of (e) in FIG. 8.

The display of visual elements such as circles, dots, lines, and dotted lines and the colors of the visual elements illustrated in FIG. 8 are examples of user interfaces (UIs) and are not limited thereto.

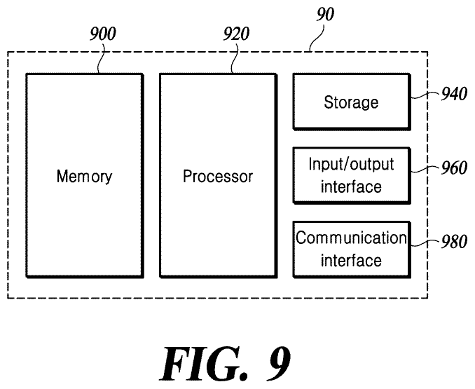

FIG. 9 is a diagram schematically illustrating the configuration of one example of a computing device that can be used to implement the apparatus and methods described in the present disclosure.

The computing device 90 may include some or all of a memory 900, a processor 920, a storage 940, an input/output interface 960, and a communication interface 980. The computing device 90 may be a stationary computing device such as a desktop computer or a server as well as a mobile computing device such as a laptop computer or a smartphone. The computing device 90 may also include any specialized hardware accelerator capable of efficiently processing operations for an artificial intelligence model. For example, the computing device 90 may include a graphic processing unit (GPU), a tensor processing unit (TPU), or a neural processing unit (NPU).

The memory 900 may store a program that causes the processor 920 to perform a method or operations according to various embodiments of the present disclosure. For example, the program may include a plurality of instructions executable by the processor 920, and the above-described method or operations may be performed by the processor 920 executing the plurality of instructions by the processor. The memory 900 may be a single memory or a plurality of memories. In this case, information required to perform the method or operations according to various embodiments of the present disclosure may be stored in a single memory or may be divided and stored in a plurality of memories. When the memory 900 is composed of a plurality of memories, the plurality of memories may be physically separated. The memory 900 may include at least one of a volatile memory and a nonvolatile memory. The volatile memory includes a static random access memory (SRAM) or a dynamic random access memory (DRAM), and the nonvolatile memory includes a flash memory or the like.

The processor 920 may include at least one core capable of executing at least one instruction. The processor 920 may execute instructions stored in the memory 900. The processor 920 may be a single processor or multiple processors.

The storage 940 maintains stored data even when power supplied to the computing device 90 is cut off. For example, the storage 940 may include a nonvolatile memory, and may include storage media such as a magnetic tape, an optical disk, or a magnetic disk. A program stored in the storage 940 may be loaded into the memory 900 before being executed by the processor 920. The storage 940 may store a file written in a programming language, and a program generated from the file by a compiler or the like may be loaded into the memory 900. The storage 940 may store data to be processed by the processor 920 and/or data processed by the processor 920.

The input/output interface 960 may provide an interface with input devices such as a keyboard and a mouse and/or output devices such as a display device and a printer. The user may trigger execution of a program by the processor 920 through an input device and/or check a processing result of the processor 920 through an output device.

The communication interface 980 may provide access to an external network. The computing device 90 may communicate with other devices through the communication interface 980.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an example description of the technical ideas of embodiments of the present disclosure. In other words, those of ordinary skill in the art to which embodiments of the present disclosure belong may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those of ordinary skill in the art should appreciate that various modifications, additions, and substitutions are possible, without departing from the idea and scope of the claims. Therefore, embodiments of the present disclosure have been described for the sake of brevity and clarity. The scope of the technical ideas of the present embodiments is not limited by the illustrations. Accordingly, one of ordinary skill should understand that the scope of the claims is not to be limited by the above explicitly described embodiments but by the claims and equivalents thereof.

What is claimed is:

1. A computer-implemented method for assisting trailer hitching, the method comprising:
initially detecting a trailer ball and a coupler using a machine learning model based on a rear-view image of a vehicle;
displaying the trailer ball and the coupler on a display using a first visual element based on a result of the initial detection;
performing a first object recognition on the coupler using the machine learning model based on the rear-view image;
displaying a location and a shape of the coupler on the display using a second visual element based on a result of the first object recognition;
performing a second object recognition on the trailer ball and the coupler using the machine learning model based on a rear-top view image of the vehicle; and
displaying locations and shapes of the trailer ball and the coupler on the display using a third visual element based on a result of the second object recognition.

2. The method of claim 1, wherein:
the first object recognition includes detecting a trailer on which the coupler is installed, performing focusing blur processing, extracting feature points, and then extracting a contour; and
the second object recognition includes detecting the coupler and the trailer ball, performing focusing blur processing, extracting feature points, and then extracting contours.

3. The method of claim 1, wherein:
when performing the first object recognition or the second object recognition, the machine learning model simplifies the trailer ball into a dot or circle shape to learn the trailer ball and simplifies the coupler into a triangle shape to learn the coupler; and
the machine learning model, as a result, learns and infers a combined shape of the trailer ball and the coupler by simplifying the combined shape into a shape in which a dot or a circle and a triangle are merged.

4. The method of claim 1, wherein the first, second, and third visual elements are figures such as a circle, a dot, a line, and/or a dotted line, and wherein colors of the first, second, and third visual elements are not limited.

5. The method of claim 1, further comprising:
generating a first path based on the result of the first object recognition;
displaying the first path on the display using a fourth visual element;
generating a second path based on the result of the second object recognition; and
displaying the second path on the display using a fifth visual element,
wherein the first, second, third, fourth and fifth visual elements are figures such as a circle, a dot, a line, and/or a dotted line, and wherein colors of the first, second, third fourth, and fifth visual elements are not limited.

6. The method of claim 5, wherein the first path is a global path and the second path is a local path.

7. An apparatus for assisting trailer hitching, the apparatus comprising:
at least one memory in which instructions are stored; and
at least one processor,
wherein the at least one processor, by executing the instructions, is configured to
initially detect a trailer ball and a coupler using a machine learning model based on a rear-view image of a vehicle,
display the trailer ball and the coupler on a display using a first visual element based on a result of the initial detection,
perform a first object recognition on the coupler using the machine learning model based on the rear-view image,
display a location and a shape of the coupler on the display using a second visual element based on a result of the first object recognition,
perform a second object recognition on the trailer ball and the coupler using the machine learning model based on a rear-top view image of the vehicle, and
display locations and shapes of the trailer ball and the coupler on the display using a third visual element based on a result of the second object recognition.

8. The apparatus of claim 7, wherein:
the first object recognition includes detecting a trailer on which the coupler is installed, performing focusing blur processing, extracting feature points, and then extracting a contour; and
the second object recognition includes detecting the coupler and the trailer ball, performing focusing blur processing, extracting feature points, and then extracting contours.

9. The apparatus of claim 7, wherein:
when performing the first object recognition or the second object recognition, the machine learning model simplifies the trailer ball into a dot or circle shape to learn the trailer ball and simplifies the coupler into a triangle shape to learn the coupler; and
the machine learning model, as a result, learns and infers a combined shape of the trailer ball and the coupler by simplifying the combined shape into a shape in which a dot or a circle and a triangle are merged.

10. The apparatus of claim 7, wherein the first, second, and third visual elements are figures such as a circle, a dot, a line, and/or a dotted line, and wherein colors of the first, second, and third visual elements are not limited.

11. The apparatus of claim 7, wherein the processor, by executing the instructions, is further configured to:
generate a first path based on the result of the first object recognition;
display the first path on the display using a fourth visual element;
generate a second path based on the result of the second object recognition; and
display the second path on the display using a fifth visual element,
wherein the first, second, third, fourth, and fifth visual elements are figures such as a circle, a dot, a line, and/or a dotted line, and wherein colors of the first, second, third, fourth, and fifth visual elements are not limited.

12. The apparatus of claim 11, wherein the first path is a global path and the second path is a local path.
